(19) United States
(12) Patent Application Publication
(10) Pub. No.: US 2006/0047959 A1
(43) Pub. Date: Mar. 2, 2006

(54) System and method for secure computing

(75) Inventor: Dinarte R. Morais, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/925,697

(22) Filed: Aug. 25, 2004

(51) Int. Cl. H04L 9/00; H04N 7/16; G06F 12/14; G06F 17/00; G06F 11/30; H04L 9/32; H04K 1/00; G06F 17/30; G06F 7/04; G06K 9/00; H03M 1/68

(52) U.S. Cl. 713/166; 713/193; 726/26; 726/1

(57) ABSTRACT

A secure execution environment is established in a computer system comprising a memory and a processor that supports the execution of different program code at different privilege levels, wherein one privilege level enables program code executing at that privilege level to map portions of memory and to assign access permissions to the mapped portions of memory, at least one of the access permissions for designating mapped memory as writable and another of the access permissions for designating mapped memory as executable. The secure executing environment is established by first program code executing at the one privilege level. The first program code, by virtue of its executing at the one privilege level, has the exclusive ability to map a portion of memory for use by other program code executing at a different privilege level and to assign access permissions to the mapped portion of memory. The first program code enforces a policy that prevents any mapped portion of memory from being designated as both writable and executable.

### CROSS-REFERENCE TO RELATED APPLICATIONS

The subject matter of this application is related to the subject matter of the following co-pending application, which is hereby incorporated by reference in its entirety:

Ser. No. ______, filed ______, entitled “System and Method for Secure Execution of Program Code” (Attorney Docket No.: MSFT-3855/308764.01).

### FIELD OF THE INVENTION

The present invention relates to computer systems, and more particularly, to systems and methods for secure execution of program code within a computer system.

### BACKGROUND OF THE INVENTION

Computer systems today are subject to a variety of attacks that can disrupt or disable normal operation of a computer system. Computer viruses, worms, and trojan horse programs are examples of different forms of attack. Attacks can also come directly from unscrupulous users of a computer system. Often these attacks take the form of attempts to modify existing program code executed by the computer system or attempts to inject new unauthorized program code at various stages of normal program execution within the computer system. Systems and methods for preventing such malicious attacks are becoming increasingly important.

A typical computer system comprises computer hardware, an operating system, and one or more application programs. The computer hardware typically comprises a processor (sometimes also referred to as a “central processing unit” or “CPU”), a memory, and one or more system buses that facilitate communication among the various components. Other components of a typical computer system include input/output controllers, a memory controller, a graphics processing unit, an audio controller, and a power supply.

The operating system can be thought of as an interface between the application programs and the underlying hardware of the computer system. The operating system typically comprises various software routines that execute on the computer system processor and that manage the physical components of the computer system and their use by various application programs.

The processor of a computer system often includes a memory management unit that manages the use of memory by the operating system and any application programs. In many computer systems, the operating system, in combination with the memory management unit, provides support for virtual memory management. Virtual memory management is a well known concept in which a “virtual” address space made available to an application program is mapped to the real, or physical address space of the computer system memory. A virtual address space appears to an application program as a contiguous range of addresses starting, for example, at a base address of zero, but in reality, the virtual address space occupies some other range of the real address space of the memory based on the mapping maintained by the operating system and memory management unit. Application programs, as well as some parts of the operating system, typically run in respective virtual address spaces within the memory, whereas other parts of the operating system may run in a portion of the real, or physical address space of the memory.

Portions of the memory, whether in the real address space or a virtual address space, may contain both data and executable program code (i.e., instructions). As used herein, the terms “code” and “program code” refer to a set of instructions that are executed by a processor of a computer system. Program code can include source code written in a high level programming language, assembly language, or machine-language, and the code can be executed in compiled form or via interpretation.

Many processors provide support for assigning different levels of “privilege” to different executable program code within a computer system as a form of security against unauthorized execution of program code. For example, some program code may be permitted to execute on the processor at a higher privilege level than other code. Generally, program code that executes at a “higher” privilege level will have greater access to certain parts of the instruction set of the processor and to the other hardware resources of the computer system.

A privilege level, sometimes also referred to as a “ring,” can be thought of as a logical division of hardware and software within a computer system. A privilege level (or ring) typically determines the total range or ranges of memory that executing program code can access as well as the range of instructions within the total instruction set of a processor that can be executed by the processor on behalf of that program code. An attempt by certain program code to access a memory range or a processor instruction outside of its privilege level typically will result in a processor fault. Program code afforded a higher privilege level (or ring) typically has privileges inclusive of that of other program code afforded a lower privilege level (or ring). Some processors support just two privilege levels, while others provide support for three, four, or more privilege levels.

For example, the architecture of the x86 series of processors manufactured by Intel Corporation provide four privilege levels, which range from “Ring 0,” the highest privilege level, to “Ring 3,” the lowest privilege level. Program code assigned to a particular privilege level can only access data and other programs which are assigned to the same or a lower privilege level. Thus, program code assigned to “Ring 2” can invoke (i.e., call) other program code assigned to Ring 2 as well as program code assigned to Ring 3, but it can not make a direct call to program code at either Ring 1 or Ring 0. As another example, the PowerPC® microprocessor architecture developed jointly by IBM Corporation, Motorola, Inc. and Apple Computer, Inc. supports three privilege levels referred to as the hypervisor mode (highest level), supervisor mode, and user mode (lowest level).

Generally, the current privilege level at which a processor executes certain program code is established by setting an appropriate bit or combination of bits in a hardware register within the processor. The details of the privileges provided at each level are implementation dependent, and not essential to the understanding of the present invention.

FIG. 1 provides further illustration of the concept of privilege levels within a processor. In the example shown, the area within the outer circle 100 represents the resources accessible by program code executing at a most privileged level (i.e., the highest privilege level), “privilege level 0,” and the area within the inner circle 102 represents resources accessible by program code executing at a lower privilege level, “privilege level 1.” The rectangle 104 on the left represents the entire instruction set provided by the processor, and the rectangle 106 on the right represents the entire range of addressable memory in the computer system. Program code executing at privilege level 0 can access the entire instruction set 104 and the entire addressable memory 106 of the computer system. However, program code executing at privilege level 1 can access only a portion 108 of the instruction set 104 (represented by the cross-hatched region of the entire instruction set) and only a portion 110 of the entire addressable memory 106. For example, program code executing at privilege level 1 may not have the ability to invoke instructions 112 that control the memory management unit of the computer system. Thus, such code would not be able to map memory or to otherwise control access to various portions of memory.

The privilege level concept is most often used to prevent full access to computing resources by application programs. Typically, an operating system developer will assign the highest privilege level to certain key portions of the operating system, such as the operating system kernel, but will relegate other operating system services and application programs to lower privilege levels. In order to obtain services that employ resources not directly available to application programs, application programs need to call operating system routines through the operating system interface. Those operating system routines can then promote the current privilege level of the processor to the higher privilege level in order to access the necessary resources, carry out the task requested by the application program, and then return control to the application program while simultaneously demoting the privilege level of the processor back to the lower level. Privilege levels can also be used to prevent the processor from executing certain privileged instructions on behalf of an application program. For example, instructions that alter the contents of certain registers in the processor may be privileged, and may be executed by the processor only on behalf of an operating system routine running at the highest privilege level. Generally, restricted instructions include instructions that manipulate the contents of control registers, such as the registers of the memory management unit, and special operating system data structures.

Another mechanism that many computer systems employ to provide security against unauthorized program code is the ability to grant different combinations of access permissions to different memory locations or to different “pages” of the computer system memory. A “page” is simply a range of memory locations within the overall memory space of a computer system. Memory is typically divided into pages of a fixed size, such as 4 kilobytes. Many processors support several types of memory access permissions that can be applied to a given page of memory, such as READ, WRITE, and EXECUTE permissions. Different combinations of these permissions can be applied to a given page of memory to effect a desired level of protection. For example, a page of memory assigned only the READ permission will be read-only, whereas a page of memory assigned both the READ and WRITE permissions can be both read and written (i.e., “read/write” access). A page or portion of memory assigned the WRITE permission is said to be “writable.” A memory page having the EXECUTE permission (which can be combined with the READ and WRITE permissions) can be used for the purpose of enabling any program code stored in the memory page to be executed. That is, program code stored in such a memory page has permission to be executed by the processor; the memory page is said to be “executable.” Typically, a table is maintained by the processor that indicates the various access permissions assigned to any memory locations that have been allocated to the operating system or an application program.

Access to memory is typically controlled by portions of the operating system through address mapping (control of the memory management unit) and assignment of access permissions to mapped locations or pages of memory. Typically, the portions of the operating system that control access to memory operate at the highest privilege level of the processor. In this manner, an application program executing at a lower privilege level can not on its own remap memory or reassign access permissions to various portions of memory.

As described more fully below, the present invention takes advantage of the privilege level and memory access permission concepts of existing computer systems to provide a more secure environment for the execution of program code to help guard against attacks from viruses, worms, trojan horses and other attacks from malicious users of a computer system.

### SUMMARY OF THE INVENTION

The present invention provides a secure computing environment that helps prevent attacks on a computer system involving attempts to modify existing program code executed by the computer system or attempts to inject new unauthorized program code at various stages of normal program code execution within the computer system. The present invention may be embodied in any computer system or computing device comprising a memory and a processor that enables different program code to execute at different privilege levels, at least one of which (but not others) permits program code executing at that privilege level to map a portion of the memory for use by other program code executing at a different privilege level and to assign access permissions to the mapped portion of memory. The access permissions that can be assigned to a mapped portion of memory include at least a permission that permits data to be written to the mapped memory (i.e., that designates the mapped memory as writable) and another permission that permits program code stored in the mapped memory to be executed by the processor (i.e., that designates the mapped memory as executable).

The secure execution environment of the present invention is established by executing first program code at the one privilege level that permits mapping of memory and assigning of access permissions to the mapped memory. The first program code, by virtue of its executing at that one privilege level, has the exclusive ability to map a portion of memory for use by other program code executing at a different privilege level and to assign access permissions to the mapped portion of memory. The first program code enforces a policy that prevents any mapped portion of memory from being designated as both writable and executable. Thus, in this execution environment, mapped memory that is writable is never be executable, and mapped memory that is executable is never writable. This prevents executable code from being modified and prevents new code from being injected into an otherwise executable memory space.

Preferably, the first program code executes in a real address space of the computer system memory. The first program code preferably also provides a programmatic interface that enables other program code executing at a privilege level that does not permit the mapping of memory or the assignment of access permissions to request that the first program code do so on its behalf. Preferably, any other program code executing on the computer system executes in a virtual address space.

The first program code may be embodied in at least part of an operating system of the computer system. The other program code will typically comprise application programs but can also comprise certain parts of an operating system.

Other features and advantages of the invention will become evident hereinafter.

### BRIEF DESCRIPTION OF THE DRAWINGS

The foregoing summary, as well as the following detailed description of the invention, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a diagram illustrating the concept of privilege levels in an exemplary computer system;

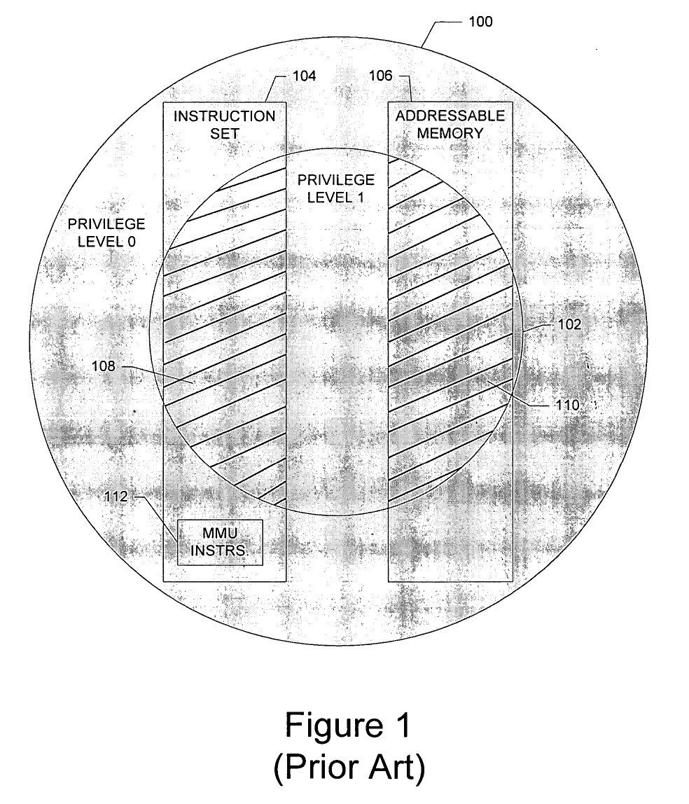

FIG. 2 is a diagram illustrating a memory of a computer system in which the present invention has been implemented; and

FIG. 3 is a block diagram of an exemplary computer environment in which aspects of the present invention may be implemented.

### DETAILED DESCRIPTION OF THE INVENTION

The present invention provides a secure computing environment that helps prevent attacks on a computer system involving attempts to modify existing program code executed by the computer system or attempts to inject new unauthorized program code at various stages of normal program code execution within the computer system. The present invention may be embodied in any computer system or computing device comprising a memory and a processor that enables different program code to execute at different privilege levels, at least one of which (but not others) permits program code executing at that privilege level to map a portion of virtual memory to a portion of real memory for use by other program code and to assign access permissions to the mapped portion of memory. In one embodiment, the access permissions that can be assigned to a portion of mapped memory include one permission that permits data to be written to the mapped memory (i.e., the memory is writable) and another permission that permits program code stored in the mapped memory to be executed by the processor (i.e., the memory is executable). It will be appreciated that different processors may implement these various forms of access permission differently. For example, one processor may provide a WRITE permission for designating a mapped portion of memory as writable and an EXECUTE permission for designating a mapped portion of memory as executable. Another processor may implement a “READ/WRITE” permission for designating a page as writable, and the ability to designate a page of memory as executable or not may instead be implemented by a NO EXECUTE permission, which when set prevents instructions from being executed from the page and when not set permits execution. It is understood that the present invention is by no means limited to any particular implementation of these various forms of access permission in any given processor.

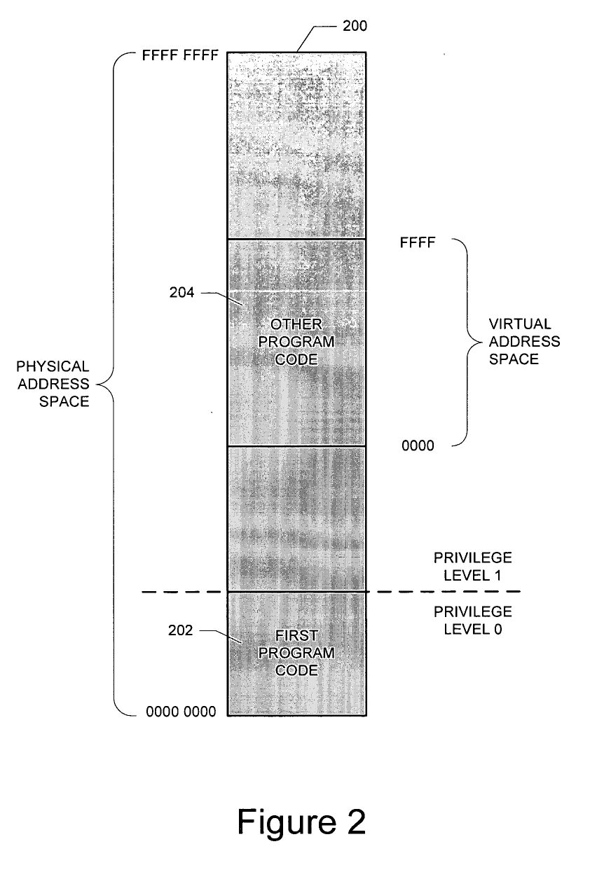

Referring to FIG. 2, which provides a map of a memory 200 of a computer system in which the present invention may be embodied, the secure execution environment of the present invention is established by providing first program code 202 that executes at a privilege level (e.g., “privilege level 0”) of a processor (not shown) of the computer system that permits the first program code 202 to map pages of virtual memory to pages of real memory and to assign access permissions to the mapped memory. For example, the first program code may have access to a memory control unit (not shown) of the processor in order to map a page of virtual memory to a page of real memory and to assign access permissions to it.

Preferably, the first program code 202 executes in a real address space of the computer system memory 200 and is not mapped to a virtual address space. Such execution is often referred to as “real mode” execution. The first program code 202 preferably provides an application programming interface (API) that other program code, such as program code 204 executing at a privilege level that does not permit the mapping of memory or the assignment of access permissions (e.g., “privilege level 1”), can invoke or call to request that the first program code 202 do so on its behalf. Preferably, the other program code 204 executes in a virtual address space within the memory 200 of the computer system which may be established and controlled by the first program code 202.

According to the present invention, the first program code 202, by virtue of its executing at the one privilege level that permits mapping of memory and assigning of access permissions, has the exclusive ability to map a portion of memory for use by other program code (such as program code 204) executing at a different privilege level and to assign access permissions to the mapped portion of memory. In addition, the first program code enforces a policy that prevents any mapped portion of memory from being designated as both writable and executable. That is, the first program code will never designate a mapped portion of memory as both writable and executable, whether at the request of other program code or otherwise. Thus, in this execution environment, mapped memory that is writable is not also executable, and mapped memory that is executable is not also writable. This prevents executable code from being modified and prevents new executable code from being injected into a memory space.

For example, in the execution environment established by the present invention, an application program cannot write program code to a data section and then “jump,” or transfer execution to, that program code because if the application program is able to write to that section of memory, that section of memory is not executable. Some virus programs, for example, attempt to inject malicious program code into the program stack, and then change the instruction pointer to the code inserted into the stack. But, in the environment of the present invention, because the stack is writable, the stack is not executable. The present invention also prevents an application program (or virus, worm, or trojan horse program) from modifying its own program code, because any memory locations that contain executable program code are not writable. Because the first program code 202 controls the mapping and assignment of access permissions to memory, it can, if desired, be used to enforce other security policies whenever an application program requests mapping of virtual memory to real memory.

It will be appreciated that the present invention can be implemented in other computer systems in which the processor supports more than the two privilege levels illustrated in FIG. 2. Preferably, however, the first program code 202 is the only code executing at a privilege level(s) that permits the mapping of memory and assignment of access permissions to it. Thus, in the example illustrated in FIG. 2, the other program code 204 could execute at other privilege levels lower than privilege level 1, such as a privilege level 2 or a privilege level 3.

The first program code 202 may comprise part of an operating system. The other program code 204 may comprise any other program code. For example, the other program code may comprise an application program or other portions of an operating system that provide functionality other than the functionality provided by the first program code 202. As used herein, the term “application program” generally refers to program code that performs a specific function directly for an end user of a computer system, as opposed to the operating system which exists to support the execution of application programs. Examples of application programs include, but are by no means limited to, spreadsheets, word processors, media players, and computer games.

Preferably, measures are taken to secure the first program code 202 to prevent direct tampering with the code. For example, the first program code 202 may be stored in a secure memory device coupled to the processor in a secure manner or implemented within the processor itself.

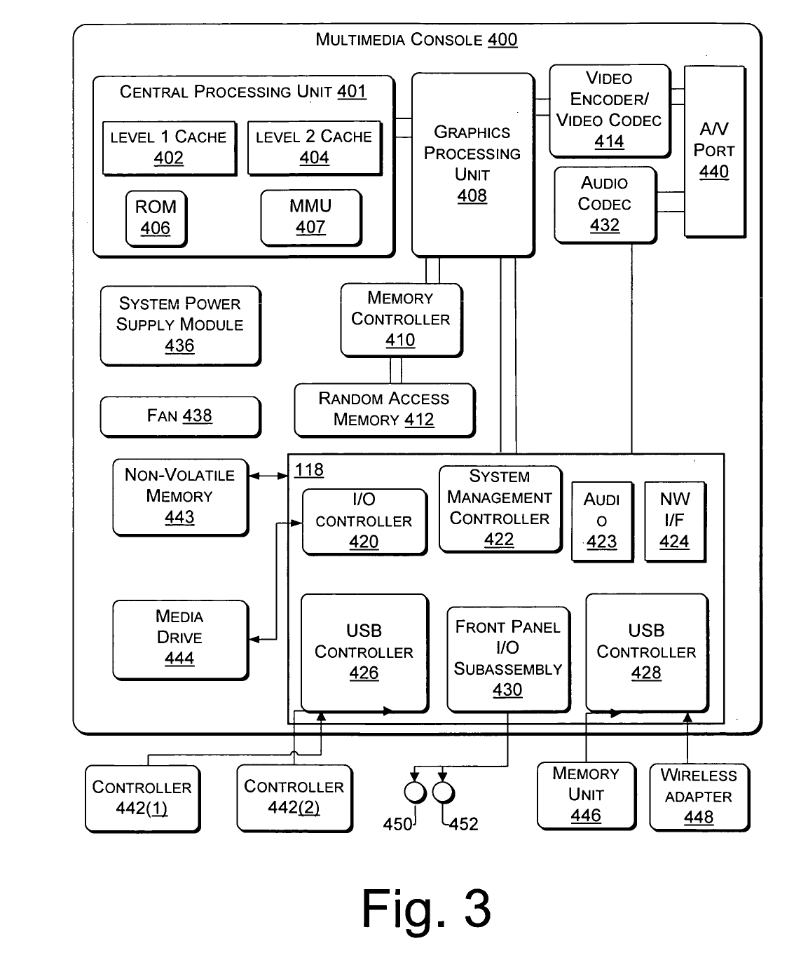

FIG. 3 illustrates the functional components of an exemplary computing device in which the present invention may be embodied. In particular, FIG. 3 illustrates the functional components of a multimedia console 400. It is understood, however, that the present invention is not limited to implementation in the multimedia console 400 of FIG. 3, but rather can be implemented in any computing device that supports different privilege levels for different program code and that restricts access to resources for mapping virtual memory to real memory and for assigning access permissions to mapped memory, including permissions used to designate memory as writable and executable (e.g., WRITE and EXECUTE permissions), to selected ones of the privilege levels.

Referring to FIG. 3, the multimedia console 400 has a central processing unit (CPU) 401 having a level 1 cache 402, a level 2 cache 404, and a ROM (Read Only Memory) 406. The CPU 401 also has a memory management unit (MMU) 407. The CPU 401 also supports the ability to assign different privilege levels to different program code executed by the processor. In this exemplary system, the CPU 401 provides three privilege levels: a hypervisor mode (most privileged), a supervisor mode, and a user mode (least privileged). Access to resources of the MMU is restricted to program code executing at a most privileged level, i.e., program code executing in the hypervisor mode. In accordance with the present invention, the first program code (202) executes in the hypervisor mode.

The level 1 cache 402 and level 2 cache 404 temporarily store data and hence reduce the number of memory access cycles, thereby improving processing speed and throughput. The CPU 401 may be provided having more than one core, and thus, additional level 1 and level 2 caches (not shown) may be present.

The ROM 406 is a secure read only memory that reduces the possibility of tampering with program code stored in it. Preferably, in accordance with the present invention, the first program code is stored in the ROM 406 and is loaded for execution during an initial phase of a boot process when the multimedia console 400 is powered ON.

A graphics processing unit (GPU) 408 and a video encoder/video codec (coder/decoder) 414 form a video processing pipeline for high speed and high resolution graphics processing. Data is carried from the graphics processing unit 408 to the video encoder/video codec 414 via a bus. The video processing pipeline outputs data to an A/V (audio/video) port 440 for transmission to a television or other display. A memory controller 410 is connected to the GPU 408 to facilitate processor access to various types of memory, such as, but not limited to, Random Access Memory(RAM) 412.

The multimedia console 400 further comprises an I/O controller 420, a system management controller 422, an audio processing unit 423, a network interface controller 424, a first USB host controller 426, a second USB controller 428 and a front panel I/O subassembly 430 that are preferably implemented on a module 418. The USB controllers 426 and 428 serve as hosts for peripheral controllers 442(1)-442(2), a wireless adapter 448, and an external memory device 446 (e.g., flash memory, external CD/DVD ROM drive, removable media, etc.). The network interface 424 and/or wireless adapter 448 provide access to a network (e.g., the Internet, home network, etc.) and may be any of a wide variety of various wired or wireless interface components including an Ethernet card, a modem, a Bluetooth module, a cable modem, and the like.

A non-volatile memory 443, such as a read-only memory or a flash memory, is provided to store application data that is loaded during the boot process. A media drive 444 is provided and may comprise a DVD/CD drive, hard drive, or other removable media drive. The media drive 444 may be internal or external to the multimedia console 400. Application data and program code may be accessed via the media drive 444 for execution, playback, etc. by the multimedia console 400. In accordance with the present invention, for example, the other program code 204 (FIG. 2) may comprise application program code accessed via the media drive 444. The media drive 444 is connected to the I/O controller 420 via a bus, such as a Serial ATA bus or other high speed connection (e.g., IEEE 1394).

The system management controller 422 provides a variety of service functions related to assuring availability of the multimedia console 400. The audio processing unit 423 and an audio codec 436 form a corresponding audio processing pipeline with high fidelity and stereo processing. Audio data is carried between the audio processing unit 423 and the audio codec 426 via a communication link. The audio processing pipeline outputs data to the A/V port 440 for reproduction by an external audio player or device having audio capabilities.

The front panel I/O subassembly 430 supports the functionality of a power button 450 and an eject button 452, as well as any LEDs (light emitting diodes) or other indicators exposed on the outer surface of the multimedia console 400. A system power supply module 436 provides power to the components of the multimedia console 400. A fan 438 cools the circuitry within the multimedia console 400.

The CPU 401, GPU 408, memory controller 410, and various other components within the multimedia console 400 are interconnected via one or more buses, including serial and parallel buses, a memory bus, a peripheral bus, and a processor or local bus using any of a variety of bus architectures.

When the multimedia console 400 is powered ON, application program code and data may be loaded from the system memory 443 into memory 412 and/or caches 402, 404 and executed on the CPU 401. Application program code and data may also be loaded into memory 412 and/or caches 402, 404 from a computer readable medium inserted in, or comprising, the media drive 414, where it can then be executed by the CPU 401. Preferably, such application program code and data is loaded into a virtual address space. As used herein, the term “computer readable medium” encompasses both volatile and nonvolatile, removable and non-removable media implemented in any method or technology for storage of information such as program code, data structures, or other information. Computer storage media include, but are not limited to, RAM, ROM, EEPROM, flash memory or other memory technology, CDROM, digital versatile disks (DVD) or other optical disk storage, memory cards, memory sticks, magnetic cassettes, magnetic tape, magnetic disk storage or other magnetic storage devices, or any other medium which can be used to store the information and which can be accessed by the console 400.

The multimedia console 400 may be operated as a standalone system by simply connecting the system to a television or other display. In this standalone mode, the multimedia console 400 allows one or more users to interact with the system, watch movies, or listen to music. However, with the integration of broadband connectivity made available through the network interface 424 or the wireless adapter 448, the multimedia console 400 may further be operated as a participant in a larger network community.

As is apparent from the above, all or portions of the system and method of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, as defined above, wherein when the program code is loaded into and executed by a machine, such as a computer or the console 400, the machine becomes an apparatus for practicing the invention. The program code may be implemented in a high level procedural or object oriented programming language. Alternatively, the program code can be implemented in an assembly or machine language. In any case, the program code may be executed in compiled form or via interpretation.

As the foregoing illustrates, the present invention is directed to systems and methods for secure execution of program code in a computer system. It is understood that changes may be made to the embodiments described above without departing from the broad inventive concepts thereof. Accordingly, it is understood that the present invention is not limited to the particular embodiments disclosed, but is intended to cover all modifications that are within the spirit and scope of the invention as defined by the appended claims.

What is claimed is:

1. A method for mapping memory in a computer system comprising a processor and a memory, wherein the processor enables different program code to execute at different privilege levels, and wherein program code executing at a first privilege level is permitted to map a portion of the memory for use by other program code and to assign access permissions to the mapped portion of memory, at least one of the access permissions for designating mapped memory as writable and another of the access permissions for designating mapped memory as executable, said method comprising:
executing first program code at the first privilege level, the first program code, by virtue of its executing at the first privilege level, having the exclusive ability to map a portion of memory for use by other program code executing at a different privilege level and to assign access permissions to a mapped portion of memory; and
enforcing a policy by the first program code that prevents any mapped portion of memory from being designated as both writable and executable.

2. The method recited in claim 1, wherein the first program code executes in a real address space of the memory of the computer system and wherein said other program code executes in a virtual address space of the memory of the computer system.

3. The method recited in claim 1, wherein the first program code comprises at least a part of an operating system.

4. The method recited in claim 1, wherein said other program code comprises an application program.

5. The method recited in claim 1, wherein the first program code exposes an application programming interface to said other code to enable said other code to request that a portion of memory be mapped by the first program code and to request that selected access permissions be assigned to a mapped portion of memory by the first program code.

6. A computer readable medium having program code stored therein for use in a computer system comprising a processor and a memory, wherein the processor supports different privilege levels, one of which permits memory to be mapped and access permissions to be assigned to the mapped memory, at least one of the access permissions for designating mapped memory as writable and another of the access permissions for designating mapped memory as executable, the program code, when executed by the processor at said one privilege level, causing the processor to perform the following steps:
mapping portions of memory for use by other program code executing at a different privilege level and assigning access permissions to mapped portions of memory; and
enforcing a policy that prevents any mapped portion of memory from being designated as both writable and executable.

7. The computer readable medium recited in claim 6, wherein the stored program code executes in a real address space of the memory of the computer system.

8. The computer readable medium recited in claim 7, wherein the other program code executes in a virtual address space of the memory of the computer system.

9. The computer readable medium recited in claim 6, wherein the stored program code comprises at least a part of an operating system.

10. The computer readable medium recited in claim 8, wherein the other program code comprises an application program.

11. A computer system comprising:
a memory and a processor that supports the execution of different program code at different privilege levels, a first privilege level enabling program code executing at that privilege level to map portions of memory and to assign access permissions to the mapped portions of memory, at least one of the access permissions for designating mapped memory as writable and another of the access permissions for designating mapped memory as executable;
first program code executing at the first privilege level; and
other program code executing a different privilege level,
wherein the first program code, by virtue of its execution at the first privilege level, has the exclusive ability to map portions of memory for use by the other program code and to assign access permissions to mapped portions of memory, and
wherein the first program code enforces a policy that prevents mapped portions of memory from being designated as both writable and executable.

12. The computer system recited in claim 11, wherein the first program code executes in a real address space of the memory of the computer system.

13. The computer system recited in claim 12, wherein the other program code executes in a virtual address space of the memory of the computer system.

14. The computer system recited in claim 11, wherein the first program code comprises at least a part of an operating system.

15. The computer system recited in claim 11, wherein the second program code comprises an application program.
